(19) United States
(12) Patent Application Publication
(10) Pub. No.: US 2011/0138300 A1
(43) Pub. Date: Jun. 9, 2011

(54) METHOD AND APPARATUS FOR SHARING COMMENTS REGARDING CONTENT

(75) Inventors: Yang-soo KIM, Yongin-si (KR); Hue-yin Kim, Anyang-si (KR); Kyung-eun Lee, Suwon-si (KR); Jong-myeong Ban, Seoul (KR); Jung-shin Park, Suwon-si (KR); Kwang-hyuk Kim, Suwon-si (KR)

(73) Assignee: Samsung Electronics Co., Ltd., Suwon-si (KR)

(21) Appl. No.: 12/964,399

(22) Filed: Dec. 9, 2010

(30) Foreign Application Priority Data
Dec. 9, 2009 (KR) 10-2009-0121940
Aug. 11, 2010 (KR) 10-2010-0077499

(51) Int. Cl. G06F 3/01; G06F 15/16

(52) U.S. Cl. 715/751

(57) ABSTRACT

A method of sharing comments including outputting an interface for receiving comments regarding content, receiving comments input to the interface, and transmitting the received comments to a storage space of a designated web site.

### PRIORITY

This application claims priority to Korean Patent Application No. 10-2009-0121940, filed on Dec. 9, 2009, and Korean Patent Application No. 10-2010-0077499, filed on Aug. 11, 2010, in the Korean Intellectual Property Office, the entire disclosures of which are incorporated herein by reference.

### BACKGROUND OF THE INVENTION

1. Field of the Invention

The present invention generally relates to a method and apparatus for sharing comments regarding content.

2. Description of the Related Art

As digital TVs become more widely distributed, they support not only their original function of a Television (TV) which outputs broadcasting content but also additional functions such as accessing the Internet.

### SUMMARY OF THE INVENTION

The present invention provides a method and apparatus for sharing comments regarding content.

According to an aspect of the present invention, there is provided a method of sharing comments, the method including providing an interface for receiving comments regarding content displayed on a display device on a screen of the display device; receiving the comments input to the interface; and transmitting the received comments to a storage space of the designated web site.

The method may further include receiving at least one additional comment for the content from the storage space of the designated web site; and outputting the at least one received additional comment.

The method may further include transmitting a request for statistics to the storage space of the designated web site, wherein the statistics comprise content preference statistics of at least one interested user who transmits the at least one additional comment to the storage space of the designated web site or content preference statistics of a user of the display device; receiving the statistics from the storage space of the designated web site; and outputting the received statistics.

According to another aspect of the present invention, there is provided an apparatus for sharing comments regarding content displayed on a display device, the apparatus including an interface managing unit for providing an interface for receiving comments regarding the content displayed on the display device on a screen of the display device; a receiving unit for receiving the comments input to the interface; and a transmitting unit for transmitting the received comments to a storage space of the designated web site

According to another aspect of the present invention, there is provided a computer readable recording medium having recorded thereon a program for executing a method of sharing comments, the method including providing an interface for receiving comments regarding content displayed on a display device on a screen of the display device; receiving the comments input to the interface; and transmitting the received comments to a storage space of the designated web site.

### BRIEF DESCRIPTION OF THE DRAWINGS

The above and other features and advantages of the present invention will become more apparent by describing in detail embodiments thereof with reference to the attached drawings in which:

FIG. 1 is a flowchart illustrating a method of sharing comments regarding content displayed on a TV, according to an embodiment of the present invention;

FIG. 2 is a flowchart illustrating a method of outputting additional comments regarding content, according to an embodiment of the present invention;

FIG. 3 is a flowchart illustrating a method of outputting content preference statistics, according to an embodiment of the present invention;

FIG. 4 is a block diagram of an apparatus for sharing comments regarding content displayed on a TV, according to an embodiment of the present invention;

FIG. 5 is a flowchart illustrating a method of transmitting comments of a TV user to a blog, according to an embodiment of the present invention;

FIG. 6 is a flowchart illustrating a method of capturing a still image of broadcasting content, according to an embodiment of the present invention;

FIG. 7 illustrates a method of transmitting comments of a TV user to a blog, according to an embodiment of the present invention;

FIG. 8 illustrates a method of transmitting comments of a TV user to a blog, according to another embodiment of the present invention;

FIG. 9 illustrates a system for executing a method of sharing comments regarding content displayed on a TV, according to an embodiment of the present invention; and

FIG. 10 illustrates a method of outputting additional comments from a TV, according to an embodiment of the present invention.

### DETAILED DESCRIPTION OF THE EMBODIMENTS OF THE PRESENT INVENTION

Hereinafter, one or more embodiments of the present invention will be described more fully with reference to the accompanying drawings.

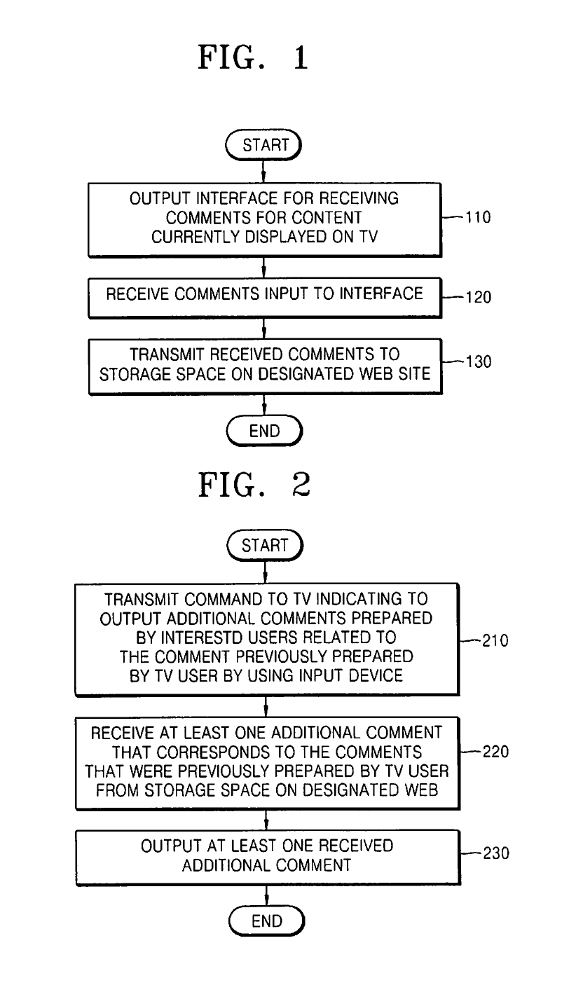

FIG. 1 is a flowchart illustrating a method of sharing comments regarding content displayed on a TV, according to an embodiment of the present invention.

In step 110, an interface for receiving comments regarding content currently displayed on a TV is outputted.

Here, the content may be image content, audio content, moving picture content, each received from an external device, or broadcasting content received from a broadcasting station. Also, comments regarding content is TV users' opinions of the content, such as questions for the content or impressions after viewing the content.

For example, when the content currently displayed on a TV is a historic drama received from a broadcasting station, the TV users may input to an interface their comments to ask questions regarding whether the characters in the drama actually existed. Also, when the content is scenery received from an external device connected to the TV, the TV users may input their comments to express their impressions on the scenery.

Also, the interface for receiving comments may be outputted by being overlapped with a portion of content currently displayed and comments input by TV users may be displayed on the interface.

In another embodiment, if a TV user sends a command for outputting an interface to receive comments to a TV through an input device, such as a remote control or a mobile phone, the TV may output the interface in response to the command.

For example, if a TV user presses a predetermined button from an input device, an interface for inputting comments may be outputted. Also, when a predetermined button is clicked on an input device and a menu screen is displayed on a TV, an item indicating to output the interface is selected from items included in the menu screen and thus the interface may be outputted.

In step 120, comments input to the interface are received.

For example, the comments input by a TV user by using an input device may be displayed on the interface in real-time or may be transmitted to a TV after a TV user inputs the comments and clicks a “completed” or “transmit” button from the input device.

In step 130, the received comments are transmitted to a storage space in a designated web site.

As described above, the comments received from a TV user are transmitted to a storage space of the designated web site so that the storage space of the designated web site stores the received comments. Accordingly, a TV user may share the comments regarding content that the user is currently watching with a third party.

It is assumed that a TV may access a network and the TV transmits comments to a storage space on the web through the network. For example, a TV may transmit comments to a storage space of the designated web site through the Internet. Also, it is obvious to one of ordinary skill in the art that the method of sharing comments according to the current embodiment of the present invention may be applied to not only a TV but also to any type of display device that displays content. For example, the method of sharing comments according to the current embodiment of the present invention may be applied to a mobile phone which displays broadcasting content through Digital Multimedia Broadcasting (DMB).

Additionally, a TV may further transmit the time when the comments were input, a still image of the content outputted when the comments were input, information about a location of the content outputted when the comments are input according to time, and a search identifier required to search for the comments regarding the content currently displayed on the web. Also, the storage space on the web may be configured to output the comments and may further output the time when the comments were input, a still image of the content outputted when the comments were input, information about a location of the content outputted when the comments were input in terms of time, and a search identifier required to search for the comments regarding the content currently displayed on the web.

Since the storage space of the designated web site outputs not only the comments but also other information related to the content of the comments, a third party connected to the storage space of the designated web site may easily understand the comments made by a TV user, which are stored in the storage space of the designated web site.

For example, when a TV user inputs comments regarding a particular scene of moving picture content in the storage space of the designated web site, it would be difficult for a third party to identify the particular scene by looking only at the comments. In this case, if the TV user stores a still image for the particular scene with the comments in the storage space of the designated web site, a third party may clearly understand the comments of the TV user.

The storage space of the designated web site, according to the embodiment of the present invention, may be a web page allocated to an individual person such as a blog or a twitter page. In the embodiment of the present invention, it is assumed that a TV user joins a blog service or a twitter service and thus storage space on the web is allocated to the TV user. When comments are received from a TV user, the received comments are transmitted to the storage space on the allocated web. A Uniform Resource Locator (URL) for connecting the storage space to the web may be previously input to a TV by a TV user or may be input to a TV by a TV user just before a TV transmits the comments to the storage space on the web.

As described above, the storage space of the designated web site may further include a search identifier so that a third party may easily search for comments input by a TV user. Here, the search identifier may be generated based on an Electronic Program Guide (EPG) for content or metadata of the content.

For example, if content currently displayed on a TV from a broadcasting station is a movie called Mission Impossible, the title “Mission Impossible” is extracted from the EPG received from the broadcasting station and then a search identifier may be generated in the form of “#Mission Impossible.” Then, when a TV user stores questions about the movie “Mission Impossible” and the search identifier “#Mission Impossible” in the storage space of the designated web site, a third party searches for the movie by inputting a search word “Mission Impossible” to a search portal, a search engine provided by a blog service, or a search engine provided by twitter and thus may access the questions about the movie “Mission Impossible” input by the TV user so as to input additional comments.

Hereinafter, comments additionally input by third parties about comments input by TV users are called additional comments and the third parties who input the additional comments are called interested users.

A TV user may transmit comments regarding content to a storage space on the web and then may desire to check additional comments about the comments input by interested users.

Hereinafter, a method of outputting additional comments on a TV input in response to comments regarding content input by a TV user will be described.

FIG. 2 is a flowchart illustrating a method of outputting additional comments regarding content, according to an embodiment of the present invention.

In step 210, a TV user transmits a command to a TV indicating to output additional comments input by interested users in response to the comment previously input by the TV user by using an input device.

For example, if a TV user transmits questions about content to a storage space of the designated web site, the additional comments input by the interested users may be answers to the questions.

In another embodiment, step 210 may be omitted.

In step 220, a TV receives at least one additional comment that corresponds to the comments that were previously input by a TV user from the storage space of the designated web site.

More specifically, a TV transmits a request to the storage space of the designated web site for transmitting at least one additional comment in response to the comments that are previously input by a TV user, and the storage space of the designated web site transmits at least one additional comment to a TV in response to the request. If a plurality of comments previously input by the TV user exist and the comments are related to each different content, information for identifying which content require additional comments may be transmitted when a TV transmits a request for the additional comments.

For example, a TV may extract a title “Mission Impossible” from the EPG and then transmit a request for additional comments including a search identifier such as “#Mission Impossible” to the storage space of the designated web site. The storage space of the designated web site searches for additional comments therein in response to the request. If the corresponding additional comments are found, the found additional comments may be transmitted to a TV.

In another embodiment, a TV may not transmit a request for additional comments to the storage space of the designated web site, and the storage space of the designated web site automatically transmits additional comments to a TV each time the additional comments that correspond to the comments previously input by a user are input. Also, the storage space of the designated web site may collect additional comments that correspond to the comments previously input by a user and transmit the collected additional comments to a TV in a predetermined period.

In step 230, the at least one received additional comment is outputted. Here, a TV may output the additional comments on an interface or on a separate area of the TV. As described above, a TV user may view the reactions of other interested users for their comments through the at least one additional comment displayed on a TV.

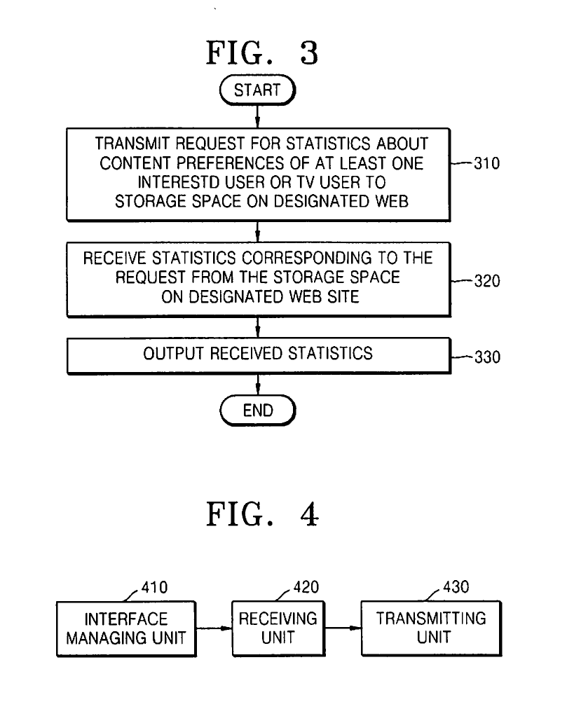

Additionally, a TV user may want to know which content is mainly viewed by interested users through a TV, that is, information about content preference. Hereinafter, a method of outputting information about content preference of a TV user or interested users on a TV will be described with reference to FIG. 3.

FIG. 3 is a flowchart illustrating a method of outputting content preference statistics, according to an embodiment of the present invention.

In step 310, a request for statistics about content preferences of at least one interested user or a TV user is transmitted to the storage space of the designated web site. Here, the storage space of the designated web site receives at least one of title and genre of content that a TV user is currently viewing in a predetermined period, generates content history about the TV users, and then produces content preference statistics about the TV users based on the content history.

Moreover, the storage space of the designated web site page to which interested users have joined receive at least one of title and genre of content that a TV user is currently viewing from TVs of the interested users, generate content history about each interested user, and then produce content preference statistics about the interested users based on the content history.

In step 320, statistics corresponding to the request are received from the storage space of the designated web site.

More specifically, when the storage space of the designated web site receives the request for content preference statistics of a TV user, the storage space of the designated web site transmits content preference statistics of the TV user stored therein to a TV.

However, the storage space of the designated web site stores the content preference statistics of the TV user and does not store the content preference statistics of interested users. Thus, if the storage space of the designated web site receives a request for content preference statistics of interested users, the storage space of the designated web site, to which each interested user has joined, are accessed, statistics about each content preference of the interested users are received, and the received statistics are transmitted to a TV of the TV user.

In step 330, the received statistics are outputted.

A user may identify information about content preference of a user or content preference of interested users by using the outputted statistics.

FIG. 4 is a block diagram of an apparatus for sharing comments regarding content displayed on a TV, according to an embodiment of the present invention. Referring to FIG. 4, the apparatus for sharing comments includes an interface managing unit 410, a receiving unit 420, and a transmitting unit 430.

The interface managing unit 410 outputs an interface for receiving comments regarding content currently displayed on a TV.

Here, the interface for receiving comments may include images and text.

The receiving unit 420 receives comments input to the interface.

The transmitting unit 430 transmits the received comments to the storage space of the designated web site.

Here, the transmitting unit 430 may further transmit the time when the comments were input, a still image of the content outputted when the comments were input, information about a location of the content outputted when the comments were input in terms of time, and a search identifier required to search for comments regarding the content currently displayed on the web, in addition to the received comments. For example, when the transmitting unit 430 receives the comments from the receiving unit 420, even if a user does not separately input a search identifier, the storage space of the designated web site receives the comments regarding the content from the transmitting unit 430 and stores the received comments.

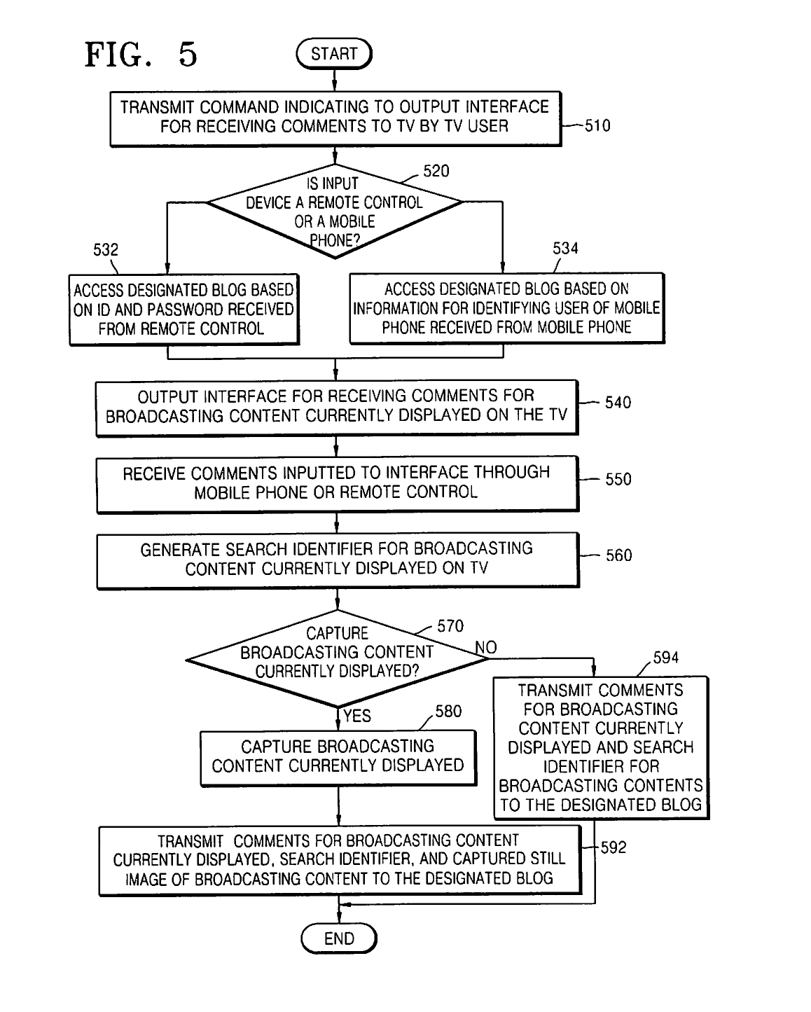

FIG. 5 is a flowchart illustrating a method of transmitting comments of a TV user to a blog, according to an embodiment of the present invention.

In step 510, a TV user transmits a command to output an interface for receiving comments to a TV through an input device, such as a remote control or a mobile phone.

In step 520, a TV determines whether the input device that transmits a command is a remote control or a mobile phone.

In step 532, when it is determined that the input device that transmits a command is a remote control, a TV receives an ID and a password needed to access a designated blog from the remote control and accesses the blog based on the received ID and password.

For example, a TV user may store a URL of the storage space on the web allocated to the TV user from the blog service the TV user has joined as access information of the designated blog, and the TV accesses the URL address based on the ID and password received from the remote control so as to access the designated blog.

In another embodiment, the TV may not access the designated blog and instead, may receive a URL of another blog to be accessed, an ID, and a password from the remote control and then may access the other blog that corresponds to the URL by using the ID and password received from the remote control.

In step 534, when it is determined that the input device that transmits a command is a mobile phone, a TV receives information for identifying a user of a mobile phone stored in the mobile phone and accesses the designated blog based on the received information for identifying the user of the mobile phone.

For example, a TV may receive a phone number from the mobile phone and information for identifying a user of the mobile phone and may access the designated blog based on the received phone number and the user identification information.

In another embodiment, a TV may receive an ID and password needed to access the designated blog from a mobile phone and may access the designated blog based on the ID and password received from the mobile phone.

In another embodiment, a TV may not access the designated blog and instead, may receive an URL address of another blog to be accessed, an ID, and a password from the mobile phone and then may access the other blog that corresponds to the URL address by using the ID and password received from the mobile phone.

In step 540, the TV outputs an interface for receiving comments regarding broadcasting content currently displayed on the TV while accessing the designated blog.

In step 550, the TV receives the comments inputted to the interface through the mobile phone or a remote control.

In step 560, a search identifier is generated based on an EPG for the broadcasting content currently displayed on the TV.

In another embodiment, the search identifier according to the embodiment of the present invention may be a hash tag.

In step 570, the TV queries the user whether to capture a still image of the broadcasting content currently displayed on the TV.

For example, the TV outputs a message asking a user whether to capture a still image of the broadcasting content currently displayed on the TV.

In step 580, when a command to accept capturing of the still image of the broadcasting content is received in response to step 570, the TV captures the still image of the broadcasting content currently displayed.

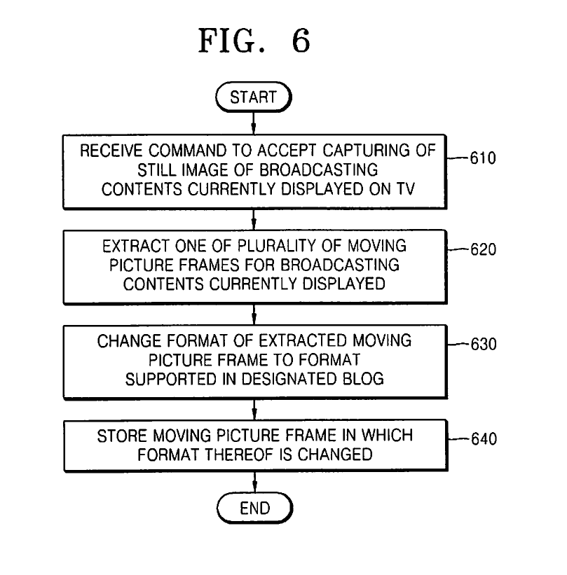

Step 580 will be described more fully later with reference to FIG. 6.

In step 592, the TV transmits the comments regarding the broadcasting content currently displayed, the search identifier, and the captured still image of the broadcasting content to the designated blog.

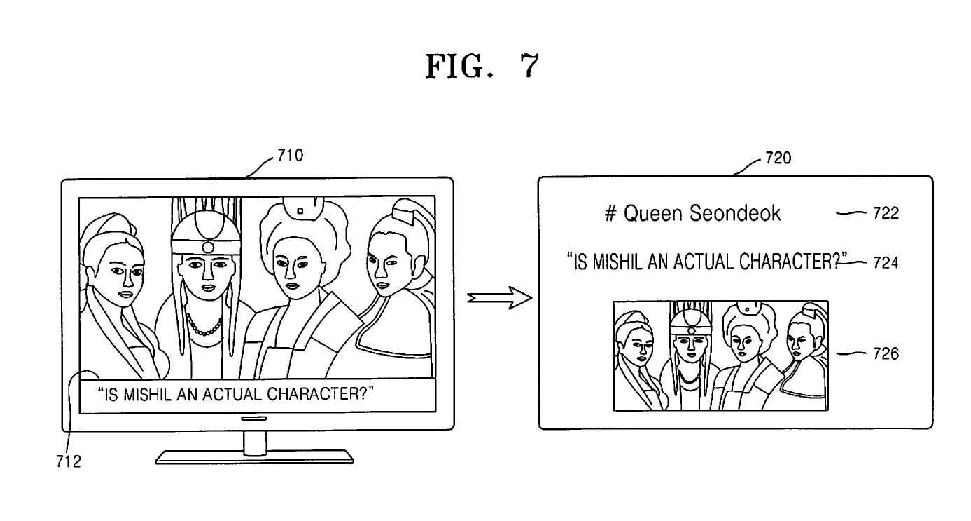

Step 592 will be described more fully later with reference to FIG. 7.

In step 594, when a command to refuse capturing the still image of the broadcasting content is received in response to step 570, the TV does not capture the still image of the broadcasting content currently displayed and only transmits the comments regarding the broadcasting content currently displayed and the search identifier to the designated blog.

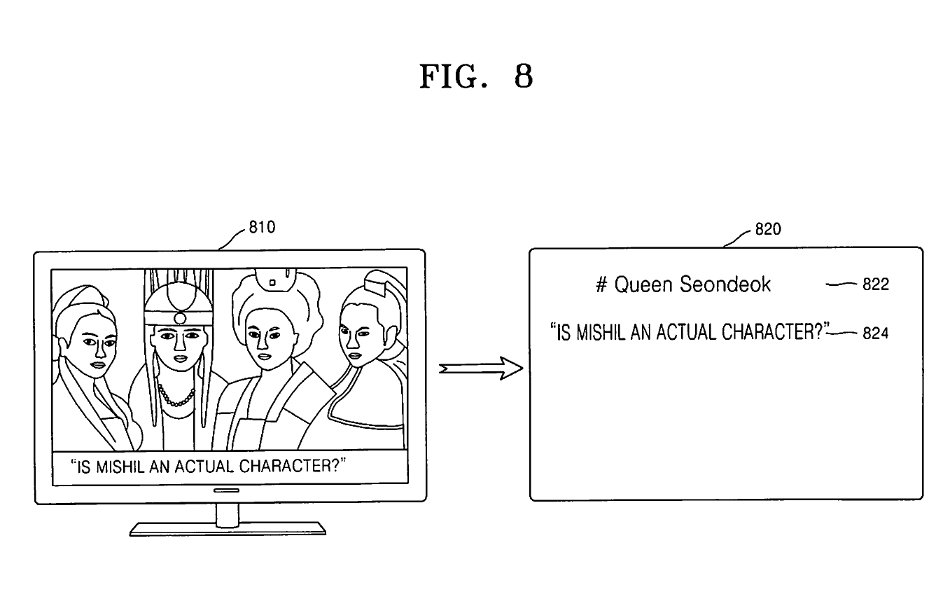

Step 594 will be described more fully later with reference to FIG. 8.

FIG. 6 is a flowchart illustrating a method of capturing a still image of broadcasting content, according to an embodiment of the present invention.

In step 610, a command to accept capturing of the still image of the broadcasting content currently displayed on a TV is received.

In step 620, the TV extracts one of a plurality of moving picture frames from the broadcasting content currently displayed.

In step 630, a format of the extracted moving picture frame is changed to a format supported by the designated blog.

In step 540, the moving picture frame, of which the format thereof is changed, is stored.

FIG. 7 is a drawing illustrating a method of transmitting comments of a TV user to a blog, according to an embodiment of the present invention.

Referring to FIG. 7, while broadcasting content called “Queen Seondeok” is displayed on a TV 710, a comment “is Mishil an actual character?” is input from a user of the TV 710 through a user interface 712 overlapping the lower portion of the broadcasting content and used to receive the outputted comment.

As such, when the comment is input, the TV 710 outputs a request message (not shown) for capturing a still image of the broadcasting content currently displayed.

In response to the capturing request message displayed on the TV 710, when a command to accept the capturing of the still image of the broadcasting content is received in the TV 710, the TV 710 captures the still image of the broadcasting content.

Finally, the TV 710 transmits a search identifier 722 “#Queen Seondeok,” a comment 724 for the broadcasting content “is Mishil an actual character?,” and a still image 726 for the broadcasting content to a blog 720.

FIG. 8 is a drawing illustrating a method of transmitting comments of a TV user to a blog, according to another embodiment of the present invention.

The embodiment of FIG. 8 is the same as the previous embodiment of FIG. 7 except that a TV 810 receives a command to refuse the capturing of the still image of the broadcasting content in response to the capturing request message displayed on the TV 710 and thus only transmits a search identifier 822 “#Queen Seondeok” and a comment 824 for the broadcasting content “is Mishil an actual character?” to a blog 820. Accordingly, a detailed description thereof is omitted in FIG. 8.

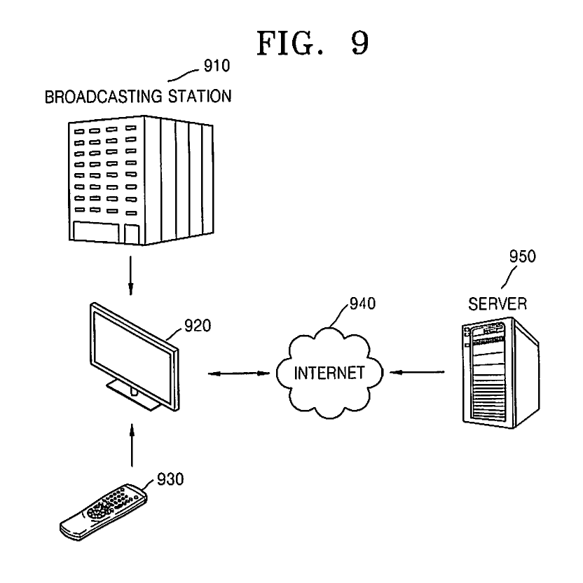

FIG. 9 is a drawing illustrating a system for executing a method of sharing comments regarding content displayed on a TV, according to an embodiment of the present invention.

Referring to FIG. 9, a TV 920 receives broadcasting content from a broadcasting station 910 and outputs the received broadcasting content. As such, when a user of the TV 920 desires to input comments regarding the broadcasting content while the broadcasting content is being output to the TV 920, the user of the TV 920 clicks a comment input button (not shown) from a remote control 930 so that the remote control 930 transmits a command indicating to output an interface for receiving the comments to the TV 920. Accordingly, the TV 920 outputs to the interface, in pop-up form, comments on the broadcasting content currently displayed.

When the interface for receiving the comments is displayed on the TV 920, the user of the TV 920 may input comments such as questions about the content currently displayed on the TV or impressions of the content by using the remote control 930.

The TV 920 transmits the comments received through the remote control 930 to a server 950 through the Internet 940.

Here, the server 950 may provide a service that provides a storage space on the web to a user of the TV 920, such as twitter, Me2day, or Facebook. When the user of the TV 920 is a user registered to a service provided by the server 950, the server 950 stores the comments transmitted from the TV 920 in the storage space allocated to the user of the TV 920 when the user of the TV 920 registers the service provided by the server 950.

Here, the storage space allocated to the user of the TV 920 is configured to output the comments transmitted from the TV 920. Accordingly, when interested users access the storage space, the interested users may check the comments of the user of the TV 920.

Also, the interested users may input additional comments that correspond to the comments of the user, which are stored in the storage space allocated to the user of the TV 920 and stores the additional comments in the storage space.

As such, when the interested users store the additional comments in the storage space, the server 950 transmits the additional comments stored in the storage space to the TV 920 through the Internet 940 when receiving a request for transmitting at least one additional comment from the TV 920.

Finally, the TV 920 outputs the additional comments received from the server 950 through the Internet 940.

Inputting comments from a user while a TV outputs broadcasting content and outputting additional comments on a TV are described above with reference to FIGS. 5 through 9; however, the present invention is not limited thereto. For example, comments may be received from a user or additional comments may be outputted on a TV, while a TV outputs image content, audio content, or moving picture content received from an external device.

Also, comments may be received from a user or additional comments may be outputted on a TV, while image content, audio content, moving picture content each received in all types of display devices, such as a mobile phone, which may display content, from an external device, or broadcasting content received from a broadcasting station are outputted.

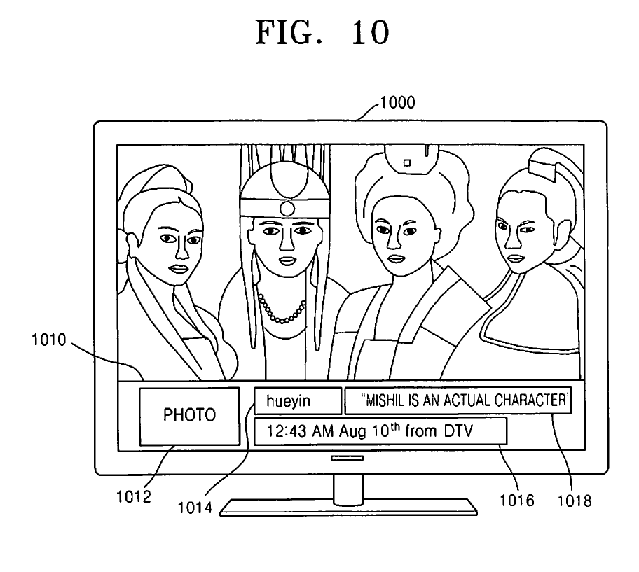

Hereinafter, outputting of additional comments from the TV 920 will be described with reference to FIG. 10.

FIG. 10 is a drawing illustrating a method of outputting additional comments from a TV 1000, according to an embodiment of the present invention.

Referring to FIG. 10, while the TV 1000 outputs broadcasting content “Queen Seondeok,” an interface 1010, shown on the lower portion of the broadcasting content and outputs additional comments.

In FIG. 10, the interface 1010 for outputting the additional comments may include a photo area 1012, an ID area 1014, a date and time area 1016, and an additional comment area 1018.

The photo area 1012 displays a photo of an interested user who inputs additional comments.

The ID area 1014 displays an ID of an interested user who has additional comments. In FIG. 10, an ID of an interested user who has additional comments is “hueyin.”

The date and time area 1016 displays the date and time when an interested user inputs additional comments. In FIG. 10, the date and time when an interested user inputs additional comments is “August 10^{th}” and 12:43 AM.” Also, “from DTV” is displayed in the date and time area 1016. As such, information about a device used to input the additional comments may be also displayed in the date and time area 1016.

The additional comment area 1018 displays the additional comment. In FIG. 10, the additional comment “Mishil is an actual character” is displayed.

The embodiments of the present invention may be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), and storage media (e.g., transmission through the Internet).

While the present invention has been particularly shown and described with reference to embodiments thereof, it will be understood by those of ordinary skill in the art that various changes in form and details may be made therein without departing from the spirit and scope of the present invention as defined by the following claims and their equivalents.

What is claimed is:

1. A method of sharing comments, the method comprising:
providing an interface for receiving comments regarding content displayed on a display device on a screen of the display device;
receiving the comments input to the interface; and
transmitting the received comments to a storage space of a designated web site.

2. The method of claim 1, further comprising:
receiving at least one additional comment for the content from the storage space of the designated web site; and
outputting the at least one received additional comment.

3. The method of claim 2, further comprising:
transmitting a request for statistics to the storage space of the designated web site, wherein the statistics comprise content preference statistics of at least one interested user who transmits the at least one additional comment to the storage space of the designated web site or content preference statistics of a user of the display device;
receiving the statistics from the storage space of the designated web site; and
outputting the received statistics.

4. The method of claim 1, wherein in the transmitting, at least one selected from the group consisting of the time when the comments are prepared, a still image of the content outputted when the comments are input, information about a location of the content outputted when the comments are prepared in terms of time is further transmitted to the storage space of the designated web site.

5. The method of claim 4, wherein the search identifier is generated based on an Electronic Program Guide (EPG) for the content or metadata of the content.

6. The method of claim 1, wherein the storage space on the web is configured to output the comments and further outputs at least one selected from the group consisting of the time when the comments are input, a still image of the content outputted when the comments are input, information about a location of the content outputted when the comments are input in terms of time.

7. The method of claim 1, further comprising transmitting at least one of title and genre of the content currently displayed on the display device to the storage space of the designated web site in a predetermined period.

8. The method of claim 1, wherein in the providing of the interface, the interface is outputted overlapping a portion of the content.

9. The method of claim 1, wherein the content comprises at least one selected from the group consisting of image content, audio content, moving picture content each received from an external device and broadcasting content received from a broadcasting station.

10. An apparatus for sharing comments regarding content displayed on a display device, comprising:
an interface managing unit for providing an interface for receiving comments regarding the content displayed on the display device on a screen of the display device;
a receiving unit for receiving the comments input to the interface; and
a transmitting unit for transmitting the received comments to a storage space of a designated web site.

11. The apparatus of claim 10, wherein the receiving unit further receives at least one additional comment for the content from the storage space of the designated web site and the interface managing unit further outputs the at least one received additional comment.

12. The apparatus of claim 11, wherein the transmitting unit further transmits a request for statistics to the storage space of the designated web site, the statistics comprising content preference statistics of at least one interested user who transmits the at least one additional comment to the storage space of the designated web site or content preference statistics of a user of the display device, the receiving unit further receives the statistics from the storage space of the designated web site, and the interface managing unit further outputs the received statistics.

13. The apparatus of claim 10, wherein the transmitting unit further transmits at least one selected from the group consisting of the time when the comments are input, a still image of the content outputted when the comments are input, information about a location of the content outputted when the comments are input in terms of time, to the storage space on the web.

14. The apparatus of claim 13, wherein the search identifier is generated based on an Electronic Program Guide (EPG) for the content or metadata of the content.

15. The apparatus of claim 10, wherein the storage space on the web is configured to output the comments and further outputs at least one selected from the group consisting of the time when the comments are input, a still image of the content outputted when the comments are input, information about a location of the content outputted when the comments are input in terms of time.

16. The apparatus of claim 10, wherein the transmitting unit further transmits at least one of title and genre of the content currently displayed on the display device to the storage space of the designated web site in a predetermined period

17. The apparatus of claim 10, wherein the interface managing unit outputs the interface by overlapping the interface with a portion of the content.

18. The apparatus of claim 10, wherein the content comprises at least one selected from the group consisting of image content, audio content, moving picture content each received from an external device and broadcasting content received from a broadcasting station.

19. A computer readable recording medium having recorded thereon a program for sharing comments, comprising:
a first code segment for providing an interface for receiving comments regarding content displayed on a display device on a screen of the display device;
a second code segment for receiving the comments input to the interface; and
a third code segment for transmitting the received comments to a storage space of a designated web site.
